(19) United States
(12) Patent Application Publication
(10) Pub. No.: US 2025/0147570 A1
(43) Pub. Date: May 8, 2025

(54) SEMICONDUCTOR SYSTEM FOR REDUCING LATENCY AND POWER CONSUMPTION AND OPERATING METHOD THEREOF

(71) Applicant: Samsung Electronics Co., Ltd., Suwon-si (KR)

(72) Inventors: Yooseok SON, Suwon-si (KR); Sehun KIM, Suwon-si (KR); Kangtae CHO, Suwon-si (KR); Wonsoo KIM, Suwon-si (KR); Saena YUK, Suwon-si (KR); Heeseong LEE, Suwon-si (KR); Younsik CHOI, Suwon-si (KR)

(73) Assignee: Samsung Electronics Co., Ltd., Suwon-si (KR)

(21) Appl. No.: 18/916,306

(22) Filed: Oct. 15, 2024

(30) Foreign Application Priority Data
Nov. 7, 2023 (KR) 10-2023-0153096

(51) Int. Cl. G06F 1/3228; G06F 1/3209

(52) U.S. Cl. CPC G06F 1/3228; G06F 1/3209

(57) ABSTRACT

Provided are a semiconductor system for reducing idle power when a specific block is idle and an operating method thereof. The semiconductor system includes a first block, the first block including a plurality of intellectual property (IP) blocks each configured to generate active information, and a first control logic configured to determine an active state of each of the plurality of IP blocks based on the active information and, in response to the active states of the plurality of IP blocks all being idle states, perform a power gating operation on the first block.

### CROSS-REFERENCE TO RELATED APPLICATION

This application is based on and claims priority under 35 U.S.C. § 119 to Korean Patent Application No. 10-2023-0153096, filed on Nov. 7, 2023, in the Korean Intellectual Property Office, the disclosure of which is incorporated by reference herein in its entirety.

### BACKGROUND

Various example embodiments relate to a semiconductor system and/or to an operating method thereof, and more particularly, to a semiconductor system for reducing idle power when a specific block is idle and/or to an operating method thereof.

A semiconductor system may include one or more blocks, and a block may include or be included in one or more intellectual property (IP) blocks, a clock management unit (CMU), and a power management unit (PMU). When a specific block is idle, idle power of the block may be reduced by performing a power off operation of an IP block, such as stopping the provision of a clock signal from a CMU to the IP block.

However, because the power off operation is controlled by an operating system (OS), the power off operation may not be performed on the specific block when the specific block is in a short idle state of several tens of milliseconds (ms) or less, due to a latency problem. Therefore, there is a need or a desire for technology to solve or improve upon a delay problem and to perform a power off operation on a block that is in a short idle state.

### SUMMARY

Various example embodiments provide a semiconductor system for effectively reducing power consumption with respect to a specific block when the specific block is idle and an operating method thereof.

According to various example embodiments, there is provided a semiconductor system including a first block, the first block including a plurality of intellectual property (IP) blocks each configured to generate active information, and a first control logic configured to determine an active state of each of the plurality of IP blocks based on the active information and, in response to the active states of the plurality of IP blocks all being idle states, perform a power gating operation on the first block.

Alternatively or additionally according to some example embodiments, there is provided an operating method of a semiconductor system including a plurality of blocks including determining an active state of each of a plurality of IP blocks included in a first block among the plurality of blocks, performing a power gating operation on the first block when the active states of the plurality of IP blocks are all idle states, and performing a wakeup operation on the first block based on a wakeup request received by a second block among the plurality of blocks.

Alternatively or additionally, there is provided an operating method of a semiconductor system including a plurality of blocks including determining an active state of each of a plurality of IP blocks included in a first block among the plurality of blocks, determining data to be transmitted from a second block among the plurality of blocks to the first block through data communication in response to the active states of the plurality of IP blocks all being idle states, stopping the data communication in response to there being no data to be transmitted through the data communication, performing a power gating operation on the first block after the data communication is stopped, and performing a wakeup operation on the first block based on a wakeup request received by the second block.

### BRIEF DESCRIPTION OF THE DRAWINGS

Embodiments will be more clearly understood from the following detailed description taken in conjunction with the accompanying drawings in which:

In order to more fully understand the drawings cited in the detailed description of the inventive concept, a brief description of each drawing is provided.

FIG. 1 is a block diagram illustrating a semiconductor system according to some example embodiments;

FIG. 2 is a block diagram illustrating a semiconductor system according to some example embodiments;

FIG. 3 is a flowchart illustrating an operating method of a semiconductor system according to some example embodiments;

FIG. 4 is a flowchart illustrating a power on/off method of a semiconductor system according to some example embodiments;

FIG. 5 is a block diagram illustrating a semiconductor system according to some example embodiments;

FIGS. 6A and 6B are graphs illustrating a stall mode operation of a semiconductor system according to some example embodiments;

FIG. 7 is a block diagram illustrating a semiconductor system according to some example embodiments;

FIGS. 8A and 8B are graphs for explaining a stall mode operation of a semiconductor system according to some example embodiments;

FIG. 9 is a block diagram illustrating an electronic device according to some example embodiments; and

FIG. 10 is a block diagram illustrating an electronic device according to some example embodiments.

### DETAILED DESCRIPTION OF VARIOUS EMBODIMENTS

Hereinafter, various example embodiments will be described in detail with reference to the attached drawings.

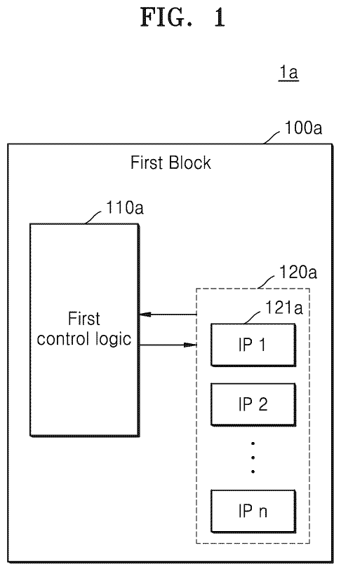

FIG. 1 is a block diagram illustrating a semiconductor system 1a according to some example embodiments.

Referring to FIG. 1, the semiconductor system 1a may be implemented as or include or be included in a personal computer (PC) and/or as a mobile device; however, example embodiments are not limited thereto. For example, the mobile device may be implemented as or include or be included in one or more of a laptop computer, a mobile phone, a smartphone, a tablet PC, a personal digital assistant (PDA), an enterprise digital assistant (EDA), a digital still camera, a digital video camera, a portable multimedia player (PMP), a personal navigation device or a portable navigation device (PND), a handheld game console, a mobile internet device (MID), a wearable computer, an Internet of things (IoT) device, an Internet of everything (IoE) device, a drone, or an e-book, but is not limited thereto.

The semiconductor system 1a may refer to a semiconductor device, and the semiconductor system 1a may be implemented as or include an integrated circuit (IC), a motherboard, a system on chip (SoC), a microprocessor, an application processor (AP), a mobile AP, a chipset, or a set of semiconductor chips, but is not limited thereto.

The semiconductor system 1a may include a first block 100a. Although it is shown that the semiconductor system 1a includes the first block 100a, the semiconductor system 1a may actually include a plurality of blocks (not shown).

The first block 100a may include a first control logic 110a and a plurality of intellectual property (IP) blocks 120a. The plurality of IP blocks 120a are function blocks that perform specific functions and may each include, for example, one or more of a central processing unit (CPU), a graphics processing unit (GPU), a neural processing unit (NPU), a communication processor (CP), a digital signal processor (DSP), a video module (e.g., a camera interface, a Joint Photographic Experts Group (JPEG) processor, a video processor, a mixer, etc.), a 3-dimensional graphics core, an audio system, or a driver. At least one of the plurality of IP blocks 120a may include at least one core that executes instructions, but example embodiments are s not limited thereto. Each of the IP blocks 121a may include individual IP blocks such as IP 1, IP 2, . . . IP n; each individual IP may communicate with one or more other IPs; in some example embodiments, individual IPs may be routed to one another; example embodiments are not limited thereto.

The first control logic 110a may determine an active state of each of the plurality of IP blocks 120a based on active information. In some example embodiments, each of the plurality of IP blocks 120a may be configured to generate the active information, and the first control logic 110a may determine whether the active state of each of the plurality of IP blocks 120a is idle or not idle based on the active information received from the plurality of IP blocks 120a. For example, when an active state of a first IP block 121a among the plurality of IP blocks 120a is idle, the first IP block 121a may generate active information of a first level (e.g., a low level). When the active state of the first IP block 121a is an operating state, the first IP block 121a may generate active information of a second level (e.g., a high level). The first control logic 110a may receive the active information from the first IP block 121a, when the received active information is the active information of the first level, may determine that the state of the first IP block 121a is the idle state, and when the received active information is the active information of the second level, may determine that the state of the first IP block 121a is the operating state (e.g., a non-idle state).

The first control logic 110a may perform a power gating operation on the first block 100a based on the active state of each of the plurality of IP blocks 120a. The power gating operation may be or may include an operation of blocking a power voltage applied to the first block 100a, so as to reduce power consumption (e.g., power consumption due to a leakage current) of the first block 100a. In some example embodiments, when active states of the plurality of IP blocks 120a are all an idle state, the first control logic 110a may determine the first block 100a to be an idle block and may perform the power gating operation on the first block 100a. For example, when the active information of each of the plurality of IP blocks 120a is the active information of the first level, as the power gating operation on the first block 100a, the first control logic 110a may block the power voltage applied to each of the plurality of IP blocks 120a. For example, when the active information of the first IP block 121a among the plurality of IP blocks 120a is the active information of the second level, the first control logic 110a may determine that the first block 100a is not an idle block and may not perform the power gating operation on the first block 100a.

The first control logic 110a may be implemented as hardware, and the first control logic 110a may perform the power gating operation on an idle block without the intervention of software (e.g., without intervention of an operating system (OS)). The power gating operation performed by the first control logic 110a is faster than the power gating operation performed by the OS, and thus, the latency of the power gating operation may be reduced. Accordingly, the first control logic 110a may perform a power off operation (e.g., the power gating operation on the idle block) even on a block that is in an idle state that is of short duration, e.g., of several tens of ms or less, and thus, power consumption in the idle state may be reduced, and as a result, the power consumption of the semiconductor system 1a may be reduced.

In some example embodiments, when the active states of the plurality of IP blocks 120a remain all in the idle states for more than a threshold time, the first control logic 110a may determine the first block 100a to be an idle block and may perform the power gating operation on the first block 100a. For example, when the active information of each of the plurality of IP blocks 120a is the active information of the first level, the first control logic 110a may determine whether each of the received active information is maintained as the active information at the first level for more than the threshold time and then may block the power voltage applied to each of the plurality of IP blocks 120a as the power gating operation on the first block 100a. When the first block 100a remains idle for less than a specific time, the power consumed by the first control logic 110a to perform a power on operation of applying the blocked power voltage again after performing the power gating operation on the first block 100a may be greater than the idle power consumed by the first block 100a. The threshold time may be or may be based on the specific time described above, and, when the first block 100a remains idle for more than the threshold time, the first control logic 110a may perform the power gating operation on the first block 100a, and thus, the power consumption may be efficiently managed.

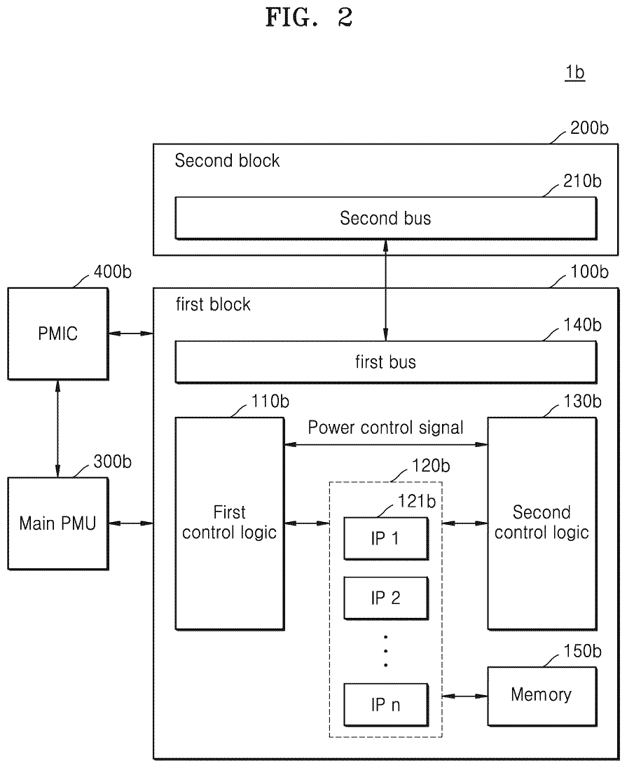

FIG. 2 is a block diagram illustrating a semiconductor system 1b according to some example embodiments.

Referring to FIG. 2, the semiconductor system 1b may include a first block 100b, a second block 200b, a main PMU 300b, and a power management integrated circuit (PMIC) 400b. Although it is shown that the semiconductor system 1b includes the first block 100b, the second block 200b, the main PMU 300b, and the PMIC 400b, the semiconductor system 1b may actually include more blocks such as a plurality of blocks (not shown).

The first block 100b may include a first control logic 110b, a plurality of IP blocks 120b, a second control logic 130b, a first bus 140b, and a memory 150b. The second block 200b may include a second bus 210b. Although it is shown that the second block 200b includes the second bus 210b, the second block 200b may further include more components, such as the same components as those of the first block 100b. The first control logic 110b and the plurality of IP blocks 120b may be respectively examples of the first control logic 110a and the plurality of IP blocks 120a of FIG. 1, and the descriptions redundant with those of FIG. 1 are omitted.

The first control logic 110b may transmit a power control signal to the second control logic 130b. The second control logic 130b may generate a clock signal and perform a clock gating operation on the first block 100b based on the power control signal. The clock gating operation may be an operation of reducing power consumption (e.g., switching power consumption) of a specific circuit by not supplying a clock signal to the specific circuit when an operation of the specific circuit is not required or is not to be performed. In some example embodiments, when the active state of the plurality of IP blocks 120b are all idle states, the first control logic 110b may determine that the first block 100b is an idle block and may transmit the power control signal to the second control logic 130b. The second control logic 130b may perform the clock gating operation on each of the plurality of IP blocks 120b based on the received power control signal. For example, the second control logic 130b may supply the clock signal to each of the plurality of IP blocks 120b and may not supply the clock signal to each of the plurality of IP blocks 120b after receiving the power control signal.

In some example embodiments, the first control logic 110b and the second control logic 130b may operate in a handshake method of exchanging a power control request and a power control acknowledgment as the power control signal. For example, when determining that the first block 100b is an idle block, the first control logic 110b may transmit a power control request to the second control logic 130b. When performing the clock gating operation on each of the plurality of IP blocks 120b, the second control logic 130b may transmit a power control accept to the first control logic 110b in response to a power control request req, and when not performing the clock gating operation on each of the plurality of IP blocks 120b, transmit a power control deny to the first control logic 110b.

The first bus 140b and the second bus 210b may each be implemented as (or may include or be included in) one or more of an advanced microcontroller bus architecture (AMBA), an advanced high-performance bus (AHB), an advanced peripheral bus (APB), an advanced eXtensible interface (AXI), an advanced system bus (ASB), an AXI coherency extensions (ACE), or a combination thereof, but are not limited thereto. In some example embodiments, the first control logic 110b may perform the power gating operation on the first bus 140b.

The first block 100b may exchange data with the second block 200b through the first bus 140b and the second bus 210b. In some example embodiments, the first bus 140b may perform data communication with the second bus 210b, and through data communication, the first block 100b may exchange data with the second block 200b.

The memory 150b is or includes a storage location storing data and may be electrically connected to each of a plurality of IP blocks. For example, the memory 150b may be electrically connected to each of the plurality of IP blocks 120b. The memory 150b may include one or more of volatile memory, such as one or more of Dynamic Random Access Memory (DRAM) and Static RAM (SRAM), or non-volatile memory, such as one or more of Phase Change RAM (PRAM), Resistive RAM (ReRAM), and Magnetic RAM (MRAM) flash memory. Although it is shown in FIG. 2 that the memory 150b is provided within the first block 100b, the memory 150b is not limited thereto and may be provided separately outside the first block 100b. In some example embodiments, the first control logic 110b may perform the power gating operation on the memory 150b.

The main PMU 300b may control a power voltage applied to each of a plurality of blocks included in the semiconductor system 1b and may perform a power gating auxiliary operation on each of the plurality of blocks. In some example embodiments, the main PMU 300b may perform the power gating auxiliary operation on the first block 100b through communication with the first control logic 110b. For example, the main PMU 300b may be implemented by or at least party implemented by software and may perform the power gating operation on the first block 100b when the first control logic 110b does not perform the power gating operation on the first block 100b that is in an idle state. In some example embodiments, when the first control logic 110b and the main PMU 300b do not perform the power gating operation on the first block 100b that is in the idle state, the main PMU 300b may transfer power gating operation failure information to a CPU (not shown). For example, when the first control logic 110b and the main PMU 300b do not perform the power gating operation on the first block 100b that is in the idle state, the semiconductor system 1b may not normally operate, and, in this case, the main PMU 300b may transfer the power gating operation failure information to a main CPU (not shown) as error information. The semiconductor system 1b may quickly perform a power off operation on an idle block (e.g., the power gating operation on an idle block) through hardware (e.g., the first control logic 110b), and, when the hardware does not normally operate, may additionally or alternatively perform a power off operation on the idle block (e.g., the power gating operation on the idle block) through software (e.g., the main PMU 300b), and thus, the power consumption of the semiconductor system 1b may be efficiently reduced.

The PMIC 400b may generate a power voltage by the control of a PMU and provide the generated power voltage to each of a plurality of blocks. In some example embodiments, the PMIC 400b may generate the power voltage by the control of the first control logic 110b and provide the generated power voltage to the first block 100b. For example, the PMIC 400b may provide power voltage to each of the plurality of IP blocks 120b. In some example embodiments, the PMIC 400b may block the power voltage to the first block 100b by the control of the first control logic 110b. For example, the first control logic 110b may determine the first block 100b as the idle block and may perform the power gating operation of controlling the PMIC 400b to block the power voltage applied to the first block 100b.

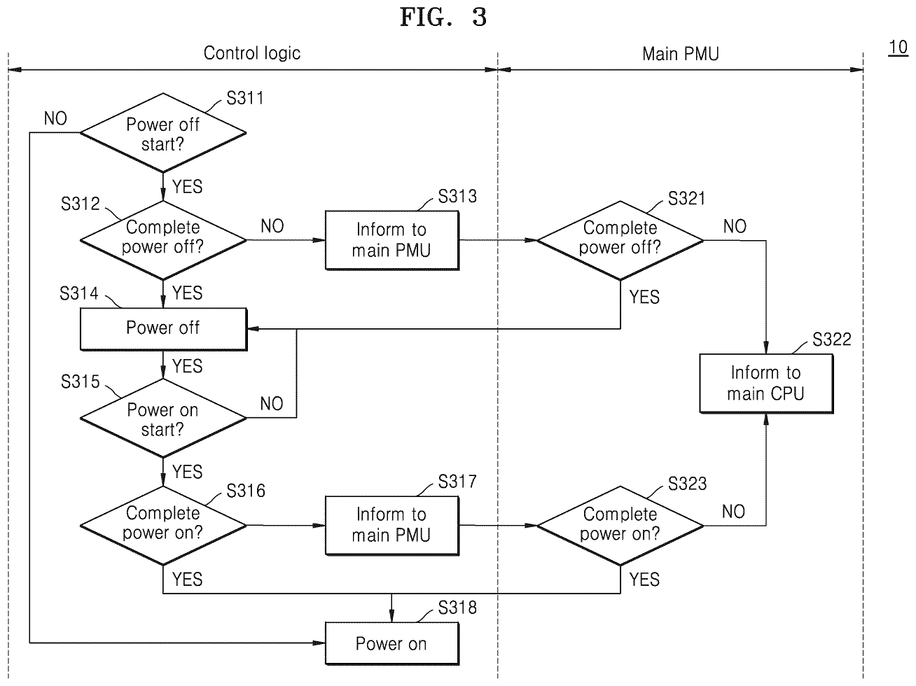

FIG. 3 is a flowchart illustrating an operating method 10 of a semiconductor system according to some example embodiments. As shown in FIG. 3, the operating method 10 of a semiconductor system may include a plurality of operations S311 to S323.

Referring to FIGS. 2 and 3, it may be determined whether to perform a power off operation in operation S311. In some example embodiments, the first control logic 110b may determine an active state of each of the plurality of IP blocks 120b based on active information. For example, each of the plurality of IP blocks 120b may be configured to generate the active information, and the first control logic 110b may determine whether the active state of each of the plurality of IP blocks 120b is the idle state, or, alternatively, whether at least one of the plurality of IP blocks 120b is not in the idle state, based on the active information received from the plurality of IP blocks 120b. In some example embodiments, the first control logic 110b may determine whether to perform the power off operation on the first block 100b based on the active state of each of the plurality of IP blocks 120b. For example, when the active states of the plurality of IP blocks 120b are all idle states, the first control logic 110b may determine the first block 100b to be an idle block and may perform the power off operation on the first block 100b that is in an idle state. For example, when the active information of a first IP block 121b among the plurality of IP blocks 120b is active information of a second level (e.g., logic high), the first control logic 110b may determine the first block 100b to be an operating block, and accordingly, a power off operation may not be performed on the first block 100b in an operating state.

When it is determined to perform the power off operation in operation S311, it may be determined whether the power off operation is completed in operation S312. In some example embodiments, the first control logic 110b may control the power voltage applied to the first block 100b, and the power off operation may include the power gating operation of reducing power consumption (e.g., power consumption due to a leakage current) of the first block 100b by blocking the power voltage applied to the first block 100b that is in the idle state. The first control logic 110b may determine whether the power off operation has been completed by determining whether the power gating operation has been completed for the first block 100b that is in the idle state.

When the power off operation is not completed in operation S312, power off operation failure information may be transferred to the main PMU 300b in operation S313. In some example embodiments, when the first control logic 110b does not perform the power gating operation on the first block 100b that is in the idle state, the first control logic 110b may transfer the power off operation failure information to the main PMU 300b.

When receiving the power off operation failure information, the main PMU 300b may determine whether the power off operation has been completed in operation S321. In some example embodiments, the main PMU 300b may control the power voltage applied to each of a plurality of blocks included in the semiconductor system 1b and perform a power gating auxiliary operation on each of the plurality of blocks. After receiving the power off operation failure information, the main PMU 300b may perform the power gating operation on the first block 100b that is in the idle state and determine whether the power off operation has been completed based on whether the power gating operation has been completed.

When the power off operation is not completed in operation S321, the power off operation failure information may be transferred to a main CPU (not shown) in operation S322. In some example embodiments, when the first control logic 110b and the main PMU 300b do not perform the power gating operation on the first block 100b that is in the idle state, the main PMU 300b may transfer the power off operation failure information to the main CPU (not shown). For example, when the first control logic 110b and the main PMU 300b do not perform the power off operation (e.g., the power gating operation) on the first block 100b that is in the idle state, the semiconductor system 1b may not normally operate, and, in this case, the main PMU 300b may transfer the power off operation failure information to the main CPU (not shown) as error information.

When the power off operation is completed in operation S312 or operation S321, the first block 100b may maintain a power off state in operation S314. In some example embodiments, the first control logic 110b or the main PMU 300b may perform the power gating operation on the first block 100b that is in the idle state. The first block 100b on which the power gating operation has been completed may be in a state where the power voltage is blocked. Accordingly, the first block 100b may maintain the power off state and may reduce idle power, and thus, power consumption of the semiconductor system 1b may be reduced. In addition, the semiconductor system 1b may quickly perform a power off operation on an idle block (e.g., the power gating operation on an idle block) through hardware (e.g., the first control logic 110b), and, when the hardware does not normally operate, may alternatively or additionally perform a power off operation on the idle block (e.g., the power gating operation on the idle block) through software (e.g., the main PMU 300b), and thus, the power consumption of the semiconductor system 1b may be efficiently reduced.

In operation S315, it may be determined whether to perform a power on operation. In some example embodiments, the first control logic 110b may determine whether to perform the power on operation on the first block 100b that is in a power off state. For example, the first control logic 110b may receive a wakeup request from the outside (e.g., the second block 200b) and determine whether to perform the power on operation based on the wakeup request.

When it is determined not to perform the power on operation in operation S315, the power off state may be maintained in operation S314. In some example embodiments, the first control logic 110b may not perform the power on operation on the first block 100b, and the first block 100b may maintain the power off state.

When it is determined to perform the power on operation in operation S315, it may be determined whether the power on operation has been completed in operation S316. In some example embodiments, the first control logic 110b may control the power voltage applied to the first block 100b, and the power on operation may include a wakeup operation of maintaining the first block 100b in an operating state by applying the blocked power voltage to the first block 100b. The first control logic 110b may determine whether the power on operation has been completed based on whether the wakeup operation on the first block 100b has been completed.

When the power on operation is not completed in operation S316, power on operation failure information may be transferred to the main PMU 300b in operation S317. In some example embodiments, when the first control logic 110b does not perform the wakeup operation on the first block 100b, the first control logic 110b may transfer the power on operation failure information to the main PMU 300b.

When receiving the power on operation failure information, the main PMU 300b may determine whether the power on operation has been completed in operation S323. In some example embodiments, the main PMU 300b may control the power voltage applied to each of the plurality of blocks included in the semiconductor system 1b and perform the wakeup operation on each of the plurality of blocks. After receiving the power on operation failure information, the main PMU 300b may perform the wakeup operation on the first block 100b and may determine whether the power on operation has been completed based on whether the wakeup operation has been completed.

When the power off operation is not completed in operation S323, the power on operation failure information may be transferred to a main CPU (not shown) in operation S322. In some example embodiments, when the first control logic 110b and the main PMU 300b do not perform the wakeup operation on the first block 100b, the main PMU 300b may transfer the power on operation failure information to the main CPU (not shown). For example, when the first control logic 110b and the main PMU 300b do not perform the power on operation (e.g., the wakeup operation) on the first block 100b, the semiconductor system 1b may not normally operate, and, in this case, the main PMU 300b may transfer the power on operation failure information to the main CPU (not shown) as error information.

When the power on operation is completed in operation S316 or operation S323, the first block 100b may maintain the power on state in operation S318. In some example embodiments, the first control logic 110b or the main PMU 300b may perform the wakeup operation on the first block 100b, and the first block 100b, on which the wakeup operation has been performed, may maintain the power on state. In addition, when the power off operation is not performed in operation S311, the first block 100b may maintain the power on state in operation S318.

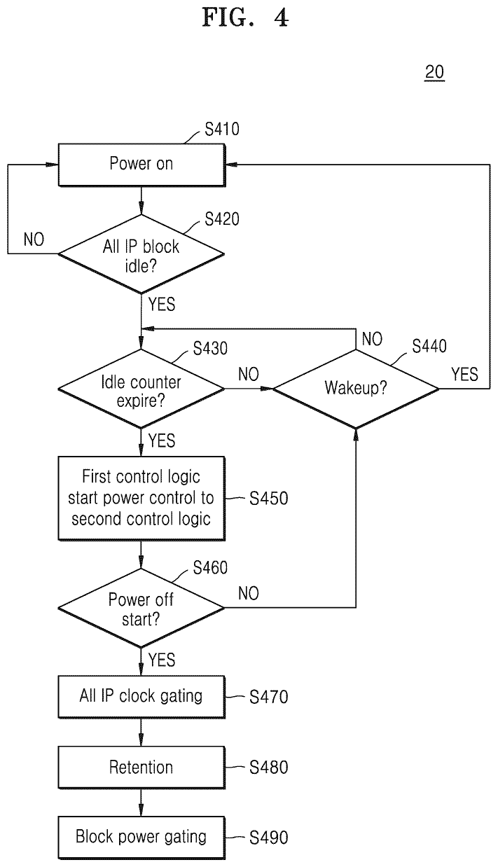

FIG. 4 is a flowchart illustrating a power on/off method 20 of a semiconductor system according to some example embodiments. As shown in FIG. 4, the power on/off method 20 of a semiconductor system may include a plurality of operations S410 to S490.

Referring to FIGS. 2 and 4, a block may maintain a power on state in operation S410, and with respect to the block that maintains the power on state, an active state of each of a plurality of IP blocks included in the block may be determined in operation S420. In some example embodiments, the first control logic 110b may receive active information of each of the plurality of IP blocks 120b from the plurality of IP blocks 120b included in the first block 100b that is in a power on state. The first control logic 110b may determine whether the active states of the plurality of IP blocks 120b are idle states based on the received active information. For example, each of the plurality of IP blocks 120b may be configured to generate the active information, and the first control logic 110b may determine that the active states of the plurality of IP blocks 120b are idle states when the active information received from each of the plurality of IP blocks 120b is active information of a first level (e.g., logic “0”). For example, when the active information of the first IP block 121b among the plurality of IP blocks 120b is active information of a second level (e.g., logic “1”), the first control logic 110b may determine that the active states of the plurality of IP blocks 120b are not idle states.

When it is determined in operation S420 that the active states of the plurality of IP blocks 120b are not (or not all) idle states, the first control logic 110b may maintain the first block 100b in the power on state in operation S410.

When it is determined in operation S420 that the active states of the plurality of IP blocks 120b are idle states, it may be determined in operation S430 whether the active states of the plurality of IP blocks 120b all remain in the idle states for more than a threshold time. In some example embodiments, when the active states of the plurality of IP blocks 120b all remain in the idle states for more than the threshold time, the first control logic 110b may determine the first block 100b to be an idle block and when at least one of the active states of the plurality of IP blocks 120b remains in the idle state for less than the threshold time, determine the first block 100b to be an active block. In some example embodiments, the first control logic 110b may also include an idle counter (not shown) that determines whether the active states of the plurality of IP blocks 120b all remain in the idle states for more than the threshold time.

When it is determined that the first block 100b is the idle block in operation S430, the first control logic 110b may perform a power control operation on the second control logic 130b in operation S450. The power control operation may be an operation of controlling the second control logic 130b to perform a clock gate operation through a power control signal. In some example embodiments, the first control logic 110b and the second control logic 130b may operate in a handshake method of exchanging a power control request req and a power control acknowledgement ack as the power control signal. For example, when it is determined that the first block 100b is the idle block, the first control logic 110b may transmit a power control request req to the second control logic 130b. When performing the clock gating operation on each of the plurality of IP blocks 120b, the second control logic 130b may transmit a power control accept to the first control logic 110b in response to the power control request req and, when not performing the clock gating operation on each of the plurality of IP blocks 120b, transmit a power control deny to the first control logic 110b.

In operation S460, it may be determined whether to perform a power off operation. In some example embodiments, the first control logic 110b may perform the power off operation on the first block 100b when receiving the power control accept and may stop the power off operation on the first block 100b when receiving the power control deny.

In operation S470, a clock gating operation may be performed on all of the plurality of IP blocks 120b. In some example embodiments, the second control logic 130b may perform the clock gating operation of reducing power consumption (e.g., switching power consumption) of the first block 100b by not supplying a clock signal to the first block 100b after transmitting the power control accept to the first control logic 110b.

In operation S480, a retention operation may be performed. The retention operation may be or may include an operation of preserving data stored in the plurality of IP blocks 120b in the memory 150b before the power gating operation. In some example embodiments, the first control logic 110b may perform the retention operation on each of the plurality of IP blocks 120b after the clock gating operation performed by the second control logic 130b is completed.

In operation S490, the power gating operation may be performed on the block. In some example embodiments, the first control logic 110b may perform the power gating operation on the first block 100b after performing the retention operation on each of the plurality of IP blocks 120b.

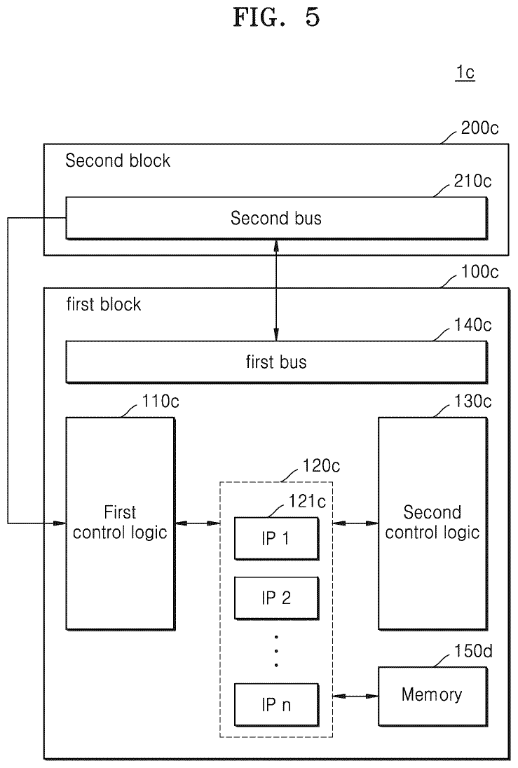

In operation S440, the power off operation may be stopped, and a wakeup operation may be performed. In some example embodiments, the first control logic 110b may receive a wakeup request from an idle counter when at least one of the active states of the plurality of IP blocks 120b remains in the idle state for less than the threshold time and, based on the received wakeup request, determine again whether the active states of the plurality of IP blocks 120b all remain in the idle states for more than the threshold time again, or perform the wakeup operation to allow the first block 100b to remain in the power on state. In some example embodiments, the first control logic 110b may perform the wakeup operation to allow the first block 100b to remain in the power on state when receiving the power control deny from the second control logic 130b or the wakeup request from the outside (e.g., the second block 200b). Various embodiments in which the wakeup request from is received from the outside are described below with reference to FIGS. 5 to 8B.

In some example embodiments, operations S410 to S460 may be referred to as a power off operation stop possible period. For example, the first control logic 110b may receive the wakeup request while performing the power off operation and may stop the power off operation based on the received wakeup request.

FIG. 5 is a block diagram illustrating a semiconductor system 1c according to some example embodiments.

Referring to FIG. 5, the semiconductor system 1c may include a first block 100c and a second block 200c. Although it is shown that the semiconductor system 1c includes the first block 100c and the second block 200c, the semiconductor system 1c may actually include more blocks such as a plurality of blocks (not shown). The first block 100c and the second block 200c may be respectively examples of the first block 100b and the second block 200b of FIG. 2, and descriptions redundant with those of FIG. 2 are omitted.

The first control logic 110c may transmit and receive a low power interface (LPI) signal to and from a first bus 140c and may perform a power off operation on the first bus 140c based on the LPI signal. The first bus 140c may transmit and receive a power down signal to and from a second bus 210c, and the second bus 210c may operate in a stall mode based on the power down signal. The first bus 140c may perform data communication with the second bus 210c, and the first block 100c may exchange data with the second block 200c through data communication. The second bus 210c may operate in the stall mode and/or in a normal mode, and the normal mode may be or correspond to a mode in which data communication between the first bus 140c and the second bus 210c is maintained. The stall mode may be or correspond to a mode in which data communication between the first bus 140c and the second bus 210c is stopped.

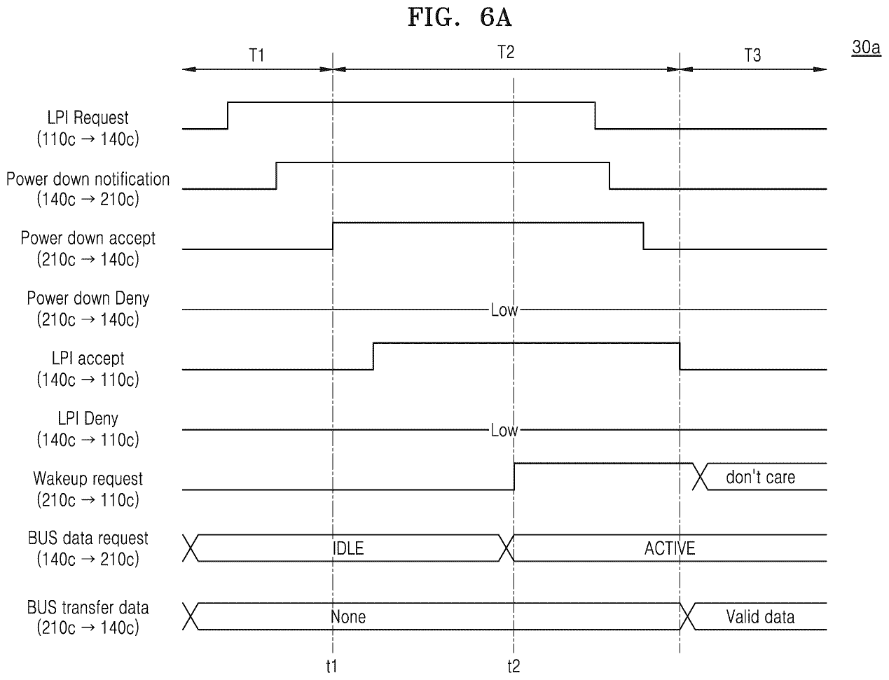

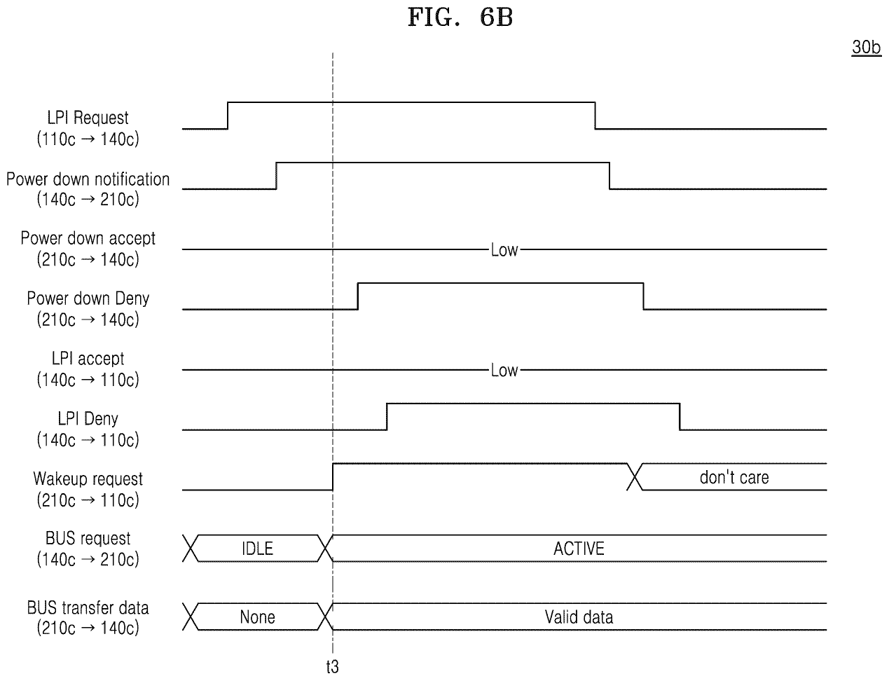

In some example embodiments, the first control logic 110c may transmit an LPI request to the first bus 140c when performing a power off operation on the first block 100c. When receiving the LPI request, the first bus 140c may transmit a power down notification to the second bus 210c. When transmitting the power down notification, the second bus 210c may transmit a power down accept or a power down deny to the first bus 140c based on whether there is data to be transmitted to the first bus 140c through data communication and determine whether to operate in the stall mode. The first bus 140c may transmit an LPI accept or LPI deny to the first control logic 110c based on the received power down signal. The first control logic 110c may determine whether to perform a power gating operation on the first bus 140c based on the received LPI signal. An embodiment related to the LPI signal and the power down signal is described below with reference to FIGS. 6A and 6B.

FIGS. 6A and 6B are first and second graphs 30a and 30b for explaining a stall mode operation of the semiconductor system 1c according to some example embodiments.

Referring to FIGS. 5 and 6A, the first graph 30a may be a graph such as a timing diagram for explaining the stall mode of the semiconductor system 1c in a process of performing a power on operation after performing a power off operation on the first block 100c. In some example embodiments, a first period T1 may be a period in which the second bus 210c operates in a normal mode. The normal mode may be a mode in which data may be exchanged through data communication between the first bus 140c and the second bus 210c. For example, the first control logic 110c may receive active information of each of the plurality of IP blocks 120c from the plurality of IP blocks 120c included in the first block 100c that is in a power on state, and, based on the received active information, may determine whether the active states of the plurality of IP blocks 120c are all idle states. When the active states of the plurality of IP blocks 120c are all idle states, the first control logic 110c may determine the first block 100c to be an idle block and may transmit an LPI request to the first bus 140c by changing, e. g., raising, the LPI request from a first level (e.g., logic “0”) to a second level (e.g., logic “1”). When receiving the LPI request of the second level, the first bus 140c may transmit a power down notification to the second bus 210c by raising the power down notification from the first level to the second level.

In some example embodiments, a second period T2 may be a period in which the second bus 210c operates in the stall mode. For example, when receiving a power down notification of the second level, the second bus 210c may determine whether there is data to be transmitted to the first bus 140c. When there is no data to be transmitted to the first bus 140c (e.g., time t1), the second bus 210c may transmit a power down accept to the first bus 140c by changing, e.g., raising, the power down accept from the first level to the second level and may operate in the stall mode. Because the second bus 210c operates in the stall mode, data communication between the first bus 140c and the second bus 210c may be stopped. When receiving a power down acknowledgment of the second level, the first bus 140c may transmit an LPI acknowledgment to the first control logic 110c by raising the LPI acknowledgment from the first level to the second level. When receiving the LPI accept of the second level, the first control logic 110c may perform a power gating operation on the first block 100c including the first bus 140c, and the first block 100c may be in a power off state. When there is data to be transferred from the second bus 210c to the first bus 140c after performing the power off operation on the first block 100c (e.g., time t2), the second bus 210c may transmit a wakeup request to the first control logic 110c by changing or raising the wakeup request from the first level to the second level. When receiving a wakeup request of the second level, the first control logic 110c may transmit the LPI request to the first bus 140c by changing, e.g., lowering the LPI request from the second level to the first level and preform a power on operation (e.g., a wakeup operation) on the first block 100c. When receiving the LPI request of the first level, the first bus 140c may transmit the power down notification to the second bus 210c by changing or lowering the power down notification from the second level to the first level. When receiving the power down notification of the first level, the second bus 210c may transmit the power down accept to the first bus 140c by changing, e.g., lowering the power down accept from the second level to the first level. In some example embodiments, the changing the levels may correspond to lowering levels and raising levels; example embodiments are not limited thereto; for example, in some cases, a logic low level may be used instead of a logic high level, while a logic high level may be used instead of a logic high level.

In some example embodiments, a third period T3 may be a period in which the second bus 210c operates in the normal mode after the stall mode. For example, the first bus 140c may transmit the LPI accept the first control logic 110c by changing or lowering the LPI accept from the second level to the first level. When the first control logic 110c receives the LPI accept of the first level, the second bus 210c may operate in the normal mode and data communication between the first bus 140c and the second bus 210c may be resumed. Accordingly, valid data may be transferred from the second bus 210c to the first bus 140c.

When a state of a specific block is in the power off state, an error may occur when data is transmitted from another block to the specific block in the power off state. The semiconductor system 1c may allow another block capable of performing data communication with the block in the power off state to operate in the stall mode and stop data communication until the power off state is converted to the power on state, and accordingly, preventing an error from occurring in the semiconductor system 1c.

Referring further to FIG. 6B, the second graph 30b may be a graph for explaining a process of stopping the power off operation and the stall mode while performing the power off operation on the first block 100c of the semiconductor system 1c. In some example embodiments, the semiconductor system 1c may stop the stall mode and the power off operation when there is data to be transferred to a block on which the power off operation is performed during a stall mode entry process. For example, when active states of the plurality of IP blocks 120c are all idle states, the first control logic 110c may determine the first block 100c to be an idle block and transmit the LPI request to the first bus 140c by changing or raising the LPI request from the first level to the second level. When receiving the LPI request of the second level, the first bus 140c may transmit the power down notification to the second bus 210c by changing or raising the power down notification from the first level to the second level. When there is data to be transmitted to the first bus 140c (e.g., time t3), the second bus 210c may transmit the wakeup request to the first control logic 110c by changing or raising the wakeup request from the first level to the second level and then transmit a power down deny to the first bus 140c by changing or raising the power down deny from the first level to the second level. At this time, the second bus 210c does not operate in the stall mode and may remain in the normal mode. When receiving the power down deny of the second level, the first bus 140c may transmit the LPI deny to the first control logic 110c by changing or raising the LPI deny from the first level to the second level. When receiving the LPI deny of the second level, the first control logic 110c may stop the power off operation on the first block 100c, and the state of the first block 100c may remain in the power on state.

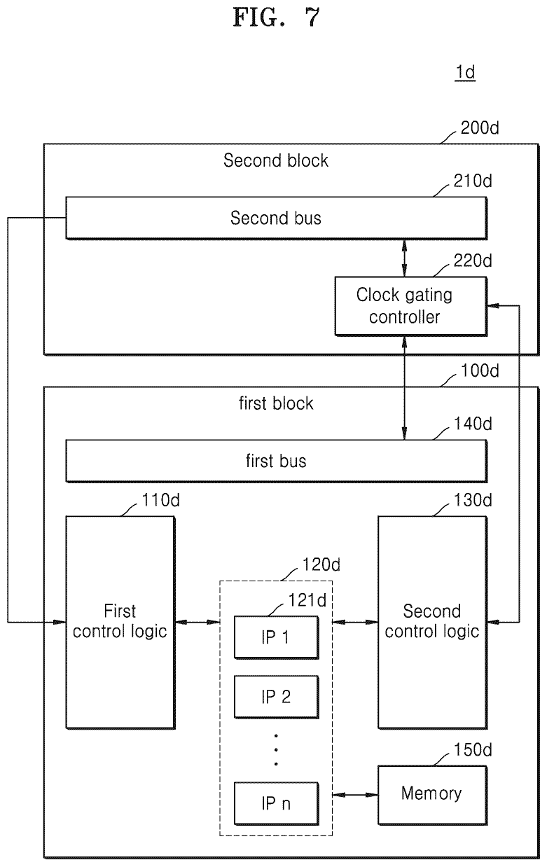

FIG. 7 is a block diagram illustrating a semiconductor system id according to some example embodiments.

Referring to FIG. 7, the semiconductor system id may include a first block 100d and a second block 200d. Although it is shown that the semiconductor system id includes the first block 100d and the second block 200d, the semiconductor system Id may actually include more blocks such as a plurality of blocks (not shown). The first block 100d and the second block 200d may be respectively examples of the first block 100b and the second block 200b of FIG. 2, and descriptions redundant with those of FIG. 2 are omitted.

A clock gating controller 220d included in the second block 200d may receive a clock signal from a second control logic 130d and may transmit and receive an LPI signal to and from the second control logic 130d. A first bus 140d may perform data communication through a second bus 210d and the clock gating controller 220d. The clock gating controller 220d may operate in a stall mode or a normal mode, and the normal mode may be a mode in which data communication between the first bus 140d and the second bus 210d is maintained. The stall mode may be a mode in which data communication between the first bus 140d and the second bus 210d is stopped.

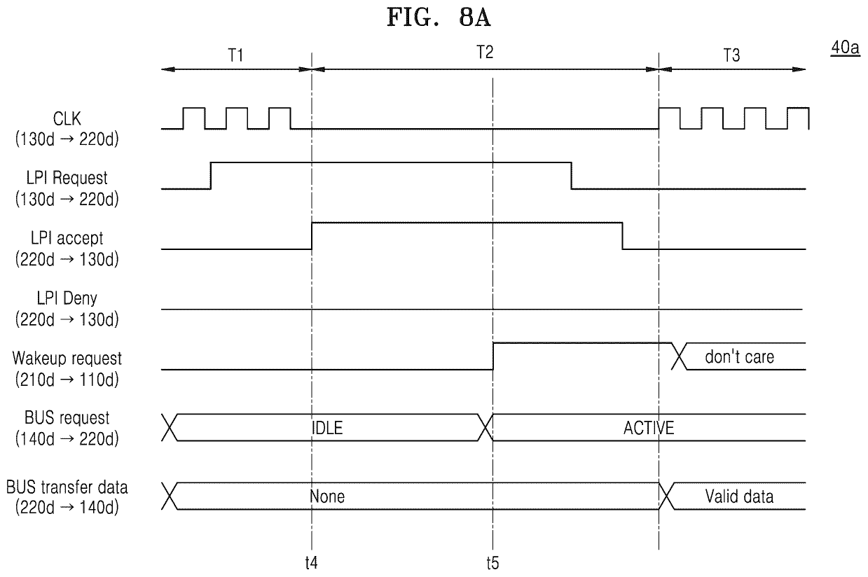

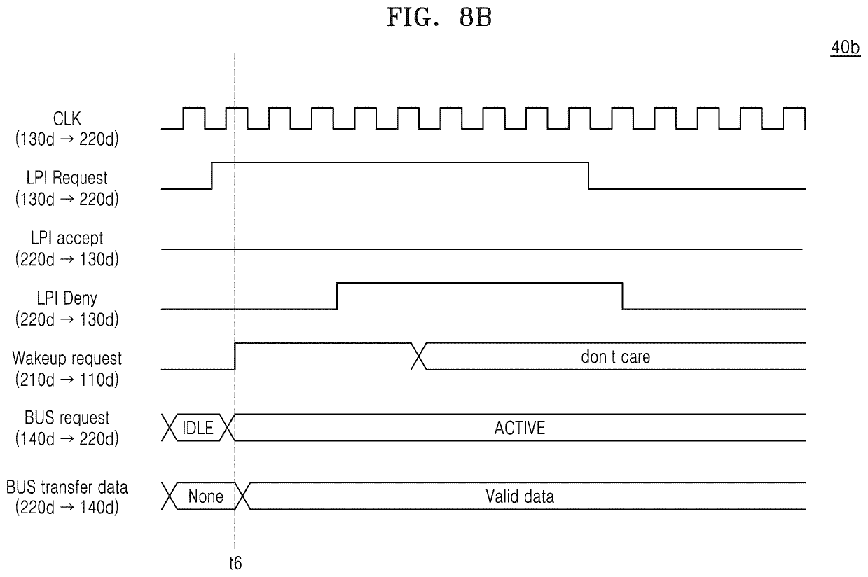

In some example embodiments, the second control logic 130d may transmit a clock signal CLK to the clock gating controller 220d, and when a first control logic 110d performs a power off operation on the first block 100d, the second control logic 130d may transmit an LPI request to the clock gating controller 220d. When receiving the LPI request, the clock gating controller 220d may transmit an LPI accept or an LPI deny to the second control logic 130d based on whether there is data to be transmitted to the first bus 140d through data communication. The second control logic 130d may control whether the clock gating controller 220d operates in the normal mode or the stall mode based on the received LPI signal through a clock gating operation on the clock gating controller 220d. An embodiment related to the LPI signal is described below with reference to FIGS. 8A and 8B.

FIGS. 8A and 8B are third and fourth graphs 40a and 40b for explaining a stall mode of the semiconductor system id according to some example embodiments.

Referring to FIGS. 7 and 8A, the third graph 40a is a graph for explaining the stall mode of the semiconductor system id in a process of performing a power on operation after performing a power off operation on the first block 100d. In some example embodiments, a fourth period T4 may be a period in which the clock gating controller 220d operates in a normal mode. For example, the first control logic 110d may receive active information of each of the plurality of IP blocks 120d from the plurality of IP blocks 120d included in the first block 100d that is in a power on state, and, based on the received active information, may determine whether the active states of the plurality of IP blocks 120d are all idle states. When the active states of the plurality of IP blocks 120d are all idle states, the first control logic 110d may perform a power control operation on the second control logic 130d. The power control operation may be an operation of controlling the second control logic 130d to perform a clock gate operation through a power control signal. After receiving a power control request as a power control signal from the first control logic 110d, the second control logic 130d may transmit an LPI request to the clock gating controller 220d by changing or raising the LPI request from a first level (e.g., logic “0”) to a second level (e.g., logic “1”).

In some example embodiments, a fifth period T5 may be a period in which the clock gating controller 220d operates in the stall mode. For example, receiving the LPI request of the second level, the clock gating controller 220d may determine whether there is data to be transmitted to the first bus 140d. When there is no data to be transmitted to the first bus 140d (e.g., time t4), the clock gating controller 220d may transmit an LPI accept to second control logic 130d by changing or raising the LPI accept from the first level to the second level. The second control logic 130d may perform a clock gating operation of stopping supplying the clock signal CLK to the clock gating controller 220d based on the LPI accept of the second level, and accordingly, the clock gating controller 220d may operate in the stall mode. Because the clock gating controller 220 operates in the stall mode, data communication between the first bus 140c and the second bus 210c may be stopped. While the clock gating controller 220d enters the stall mode, the first control logic 110d may perform the power off operation on the first block 100d, and the first block 100d may be in a power off state. When there is data to be transferred to the first bus 140d after performing the power off operation on the first block 100d (e.g., time t5), the second bus 210d may transmit a wakeup request to the first control logic 110d by changing or raising the wakeup request from the first level to the second level, and the second control logic 130d may transmit the LPI request to the clock gating controller 220d by changing or lowering the LPI request from the second level to the first level. When receiving the LPI request of the first level, the clock gating controller 220d may transmit the LPI accept to the second control logic 130d by changing or lowering the LPI accept from the second level to the first level.

In some example embodiments, a sixth period T6 may be a period in which the clock gating controller 220d operates in the normal mode after the stall mode. For example, when receiving the LPI accept of the first level, the second control logic 130d may transmit the clock signal CLK to the clock gating controller 220d. Accordingly, valid data may be transferred from the second bus 210d to the first bus 140d through the clock gating controller 220d.

When a state of a specific block is in the power off state, an error may occur when data is transmitted from another block to the specific block in the power off state. The semiconductor system id may allow another block capable of performing data communication with the block in the power off state to operate in the stall mode and stop data communication until the power off state is converted to the power on state, and accordingly, preventing an error from occurring in the semiconductor system Id.

Referring further to FIG. 8B, the fourth graph 40d may be a graph for explaining a process of stopping the power off operation and the stall mode while performing the power off operation on the first block 100d of the semiconductor system Id. In some example embodiments, the semiconductor system id may stop the stall mode and the power off operation when there is data to be transferred to a block on which the power off operation is performed during a stall mode entry process. For example, when active states of the plurality of IP blocks 120d are all idle states, the first control logic 110d may determine the first block 100d to be an idle block, and the second control logic 110d may perform a power control operation on the second control logic 130d. After receiving the power control request as the power control signal from the first control logic 110d, the second control logic 130d may transmit the LPI request to the clock gating controller 220d by changing or raising the LPI request from the first level (e.g., logic “0”) to the second level (e.g., logic “1”). When there is data to be transmitted to the first bus 140d after the clock gating controller 220d receives the LPI request of the second level (e.g., time t6), the second bus 210d may transmit a wakeup request to the first control logic 110d by changing or raising the wakeup request from the first level to the second level, and the clock gating controller 220d may transmit an LPI deny to the second control logic 130d by changing or raising the LPI deny from the first level to the second level. When receiving the LPI deny of the second level, the second control logic 130d may not perform the clock gating operation on the clock gating controller 220d, and the clock gating controller 220d may remain in the normal mode. When receiving the wakeup request of the second level, the first control logic 110d may stop the power off operation on the first block 100d, and the state of the first block 100d may maintain the power on state.

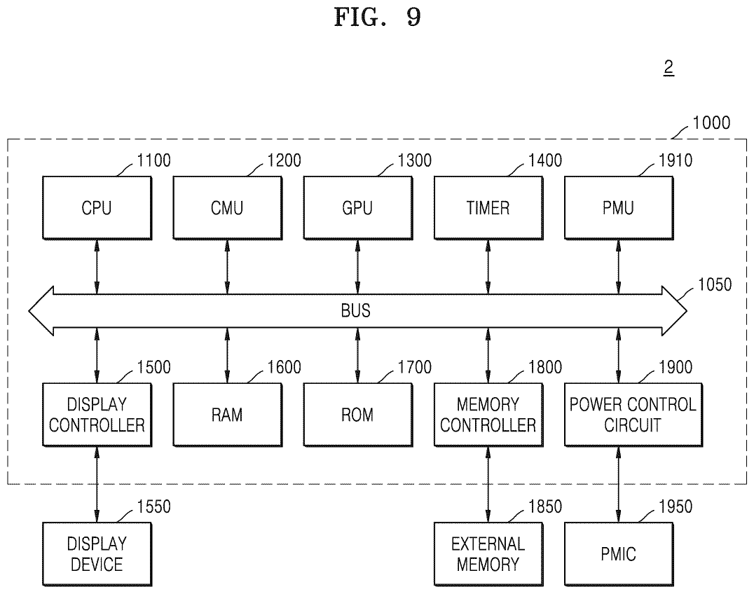

FIG. 9 is a block diagram illustrating an electronic device 2 according to some example embodiments.

Referring to FIG. 9, the electronic device 2 may be implemented as or include or be included in one or more of a handheld device such as a mobile phone, a smartphone, a tablet PC, a PDA, an EDA, a digital still camera, a digital video camera, a PMP, a PND, a handheld game console, or an e-book.

The electronic device 2 may include a SoC 1000, an external memory 1850, a display device 1550, and a PMIC 1950.

The SoC 1000 may include a CPU 1100, a clock management unit (CMU) 1200, a (GPU 1300, a timer 1400, a display controller 1500, a random access memory (RAM) 1600, read only memory (ROM) 1700, a memory controller 1800, a PMU, and a bus 1050. The SoC 1000 may further include other components in addition to the components shown. For example, the electronic device 2 may further include the display device 1550, the external memory 1850, and the PMIC 1950. The PMIC 1950 may be implemented outside the SoC 1000. However, the SoC 1000 is not limited thereto and may include a PMU capable of performing a function of the PMIC 1950.

The CPU 1100 may also be referred to as a processor and may process or execute programs and/or data stored in the external memory 1850. For example, the CPU 1100 may process or execute programs and/or data in response to an operation clock signal output from the CMU 1200.

The CPU 1100 may be implemented as a multi-core processor. The multi-core processor may be one computing component having two or more independent physical processors (referred to as ‘cores’), and each of the processors may read and execute program instructions. The programs and/or data stored in the ROM 1700, the RAM 1600, and/or the external memory 1850 may be loaded into a memory (not shown) of the CPU 1100 as needed.

The CMU 1200 may generate an operation clock signal. The CMU 1200 may include a clock signal generating device, such as a phase locked loop (PLL), a delayed locked loop (DLL), or a crystal oscillator.

The operation clock signal may be supplied to the GPU 1300. The operation clock signal may be supplied to other components (e.g., the CPU 1100 or the memory controller 1800, etc.). The CMU 1200 may change a frequency of the operation clock signal.

The GPU 1300 may convert data read from the external memory 1850 by the memory controller 1800 into a signal suitable for the display device 1550.

The timer 1400 may output a count value indicating time based on the operation clock signal output from the CMU 1200.

The display device 1550 may display image signals output from the display controller 1500. For example, the display device 1550 may be implemented as (or include or be included in) one or more of a liquid crystal display (LCD), a light emitting diode (LED) display, an organic LED (OLED) display, an active-matrix OLED (AMOLED) display, or a flexible display. The display controller 1500 may control an operation of the display device 1550.

The RAM 1600 may temporarily store programs, data, or instructions. For example, the programs and/or data stored in the memory may be temporarily stored in the RAM 1600 by the control of the CPU 1100 or according to a booting code stored in the ROM 1700. The RAM 1600 may be implemented as or include DRAM and/or SRAM.

The ROM 1700 may store permanent programs and/or data. The ROM 1700 may be implemented as or include erasable programmable read-only memory (EPROM) and/or electrically erasable programmable read-only memory (EEPROM).

The memory controller 1800 may communicate with the external memory 1850 through an interface. The memory controller 1800 may control all operations of the external memory 1850 and control data exchange between a host and the external memory 1850. For example, the memory controller 1800 may write data to or read data from the external memory 1850 at a request of the host. Here, the host may be a master device such as the CPU 1100, the GPU 1300, or the display controller 1500.

The external memory 1850 is a storage medium storing data, and may store an OS, various programs, and/or various data. The external memory 1850 may be, for example, DRAM, but is not limited thereto. For example, the external memory 1850 may be or may include a non-volatile memory device (e.g., one or more of flash memory, PRAM, MRAM, RRAM, or FeRAM device). Alternatively or additionally, the external memory 1850 may be an internal memory provided inside the SoC 1000. In addition, the external memory 1850 may be or include one or more of flash memory, embedded multimedia card (eMMC), or universal flash storage (UFS).

The PMU 1910 may control a voltage required for each device connected to the SoC 1000 to operate. In some example embodiments, the SoC 1000 may include a plurality of blocks (e.g., the CPU 1100, the GPU 1300, or the bus 1050), and PMU 1910 may perform a power on/off operation on each of the plurality of blocks. The PMU 1910 may be the same as the first control logic 110b described above in FIG. 2. For example, the PMU 1910 may be implemented as hardware. The PMU 1910 may determine whether the state of the CPU 1100, the GPU 1300, or the bus 1050 is an idle state, and, when it is determined that the state of the CPU 1100, the GPU 1300, or the bus 1050 is the idle state, perform a power gating operation on the CPU 1100, the GPU 1300, or the bus 1050. The power gating operation on the plurality of blocks by the PMU 1910 may be a faster operation than the power gating operation performed by the OS, and the latency of the power gating operation may be reduced. Accordingly, the PMU 1910 may perform a power off operation (e.g., the power gating operation on an idle block) even on a block that is in a short idle state of several tens of ms or less, and thus, idle power may be reduced, and the power consumption of a semiconductor system may be reduced.

The CPU 1100, the CMU 1200, the GPU 1300, the timer 1400, the display controller 1500, the RAM 1600, the ROM 1700, the memory controller 1800, the power control circuit 1900, the PMU 1910 may communicate with each other via the bus 1050.

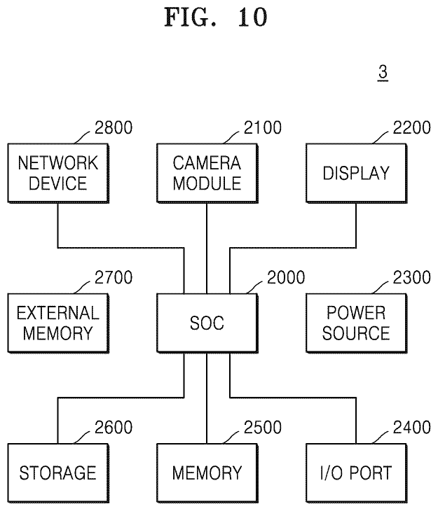

FIG. 10 is a block diagram illustrating an electronic device 3 according to some example embodiments.

Referring to FIG. 10, the electronic device 3 may be implemented as a PC, a data server, or a portable electronic device.

The electronic device 3 may include a SoC 2000, a camera module 2100, a display 2200, a power source 2300, an input/output (I/O) port 2400, a memory 2500, a storage 2600, an external memory 2700, and a network device 2800.

The SoC 2000 may include a plurality of blocks (e.g., the CPU 1100, the GPU 1300, or the bus 1050 of FIG. 9) (not shown), and each of the plurality of blocks may include the same circuit (not shown) as the first control logic 110b described above in FIG. 2. For example, the circuit (not shown) included in each of the plurality of blocks may be implemented as hardware, and may determine whether a state of each of the plurality of blocks (not shown) is an idle state. The circuit (not shown) may perform a power gating operation on each of the plurality of blocks (not shown) when the state of each of the plurality of blocks (not shown) is the idle state. The power gating operation on each of the plurality of blocks by the circuit (not shown) may be a faster operation than a power gating operation by an OS, and the latency of the power gating operation may be reduced. Accordingly, the circuit (not shown) may perform a power off operation (e.g., the power gating operation on an idle block) even on a block that is in a short idle state of several tens of ms or less, and thus, idle power may be reduced, and the power consumption of a semiconductor system may be reduced.

The camera module 2100 may be a module capable of converting an optical image into an electrical image. Accordingly, the electrical image output from the camera module 2100 may be stored in the storage 2600, the memory 2500, or the external memory 2700. In addition, the electrical image output from the camera module 2100 may be displayed through the display 2200.

The display 2200 may display data output from the storage 2600, the memory 2500, the I/O port 2400, the external memory 2700, or the network device 2800. The display 2200 may be the display device 1550 shown in FIG. 9.

The power source 2300 may supply an operating voltage to at least one of the components. The power source 2300 may be controlled by the PMIC 1950 shown in FIG. 9.

The I/O port 2400 may be ports capable of transmitting data to the electronic device 1 or transmitting data output from the electronic device 2 to an external device. For example, the I/O port 2400 may include a port connecting a pointing device such as a computer mouse, a port connecting a printer, or a port connecting a USB drive.

The memory 2500 may be implemented as volatile memory or non-volatile memory. According to some example embodiments, a memory controller capable of controlling a data access operation on the memory 2500, such as a read operation, a write operation (or a program operation), or an erase operation, may be integrated or embedded in the SoC 2000. According to another embodiment, the memory controller may be implemented between the SoC 2000 and the memory 2500.

The storage 2600 may be implemented as or may include a hard disk drive and/or solid state drive (SSD).

The external memory 2700 may be implemented as or may include a secure digital (SD) card and/or a multimedia card (MMC). According to some example embodiments, the external memory 2700 may be a subscriber identification module (SIM) card or a universal subscriber identity module (USIM) card.

The network device 2800 may be a device capable of connecting the electronic device 3 to a wired network and/or a wireless network.

Any or all of the elements described with reference to FIG. 10 may communicate with any or all other elements described with reference to FIG. 10. For example, any element may engage in one-way and/or two-way and/or broadcast communication with any or all other elements in FIG. 1, to transfer and/or exchange and/or receive information such as but not limited to data and/or commands, in a serial and/or parallel manner, via a wireless and/or a wired bus (not illustrated). The information may be in encoded various formats, such as in an analog format and/or in a digital format.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

While various inventive concepts have been particularly shown and described with reference to embodiments thereof, it will be understood that various changes in form and details may be made therein without departing from the spirit and scope of the following claims. Example embodiments are not necessarily mutually exclusive. For example, some example embodiments may include one or more features described with reference to one or more figures, and may also include one or more other features described with reference to one or more other figures.

What is claimed is:

1. A semiconductor system comprising:
a plurality of processing blocks comprising a first processing block; and
a controller configured to control the plurality of processing blocks,
wherein the first processing block comprises
a plurality of intellectual property (IP) blocks each configured to generate active information, and
a first control logic configured to determine an active state of each of the plurality of IP blocks based on the active information, and, in response to the active states of the plurality of IP blocks all being idle states, perform a power gating operation on the first processing block.

2. The semiconductor system of claim 1, wherein the first control logic is configured to perform the power gating operation in response to the active states of the plurality of IP blocks all remaining in the idle states for more than a threshold time.

3. The semiconductor system of claim 1, wherein
the plurality of processing blocks further include a second processing block including a second bus,
the first processing block further includes a first bus configured to perform data communication with the second bus, and
the second bus is configured to operate in a stall mode in which data communication is stopped in response to no data being present to be transmitted to the first bus through the data communication after receiving a power down notification through the first bus.

4. The semiconductor system of claim 3, wherein
the first control logic is configured to transmit a low power interface (LPI) request to the first bus based on the active state,
the first bus is configured to transmit the power down notification to the second bus after receiving the LPI request, and
the second bus is configured to operate in the stall mode in response to no data being present to be transmitted to the first bus through the data communication after receiving the power down notification.

5. The semiconductor system of claim 4, wherein
the second bus is configured to transmit a wakeup request to the first control logic in response to data being present to be transmitted to the first bus through the data communication while operating in the stall mode, and
the first control logic is configured to perform a wakeup operation on the first processing block based on the wakeup request.

6. The semiconductor system of claim 4, wherein
the second bus is configured to transmit a power down deny to the first bus in response to there being data to be transmitted to the first bus through the data communication after receiving the power down notification,
the first bus is configured to transmit an LPI deny to the first control logic based on the power down deny, and
the first control logic is configured to perform a wakeup operation on the first processing block based on the LPI deny.

7. The semiconductor system of claim 1, wherein
the first control logic is configured to generate a power control signal in response to the active states of the plurality of IP blocks being in the idle states, and
the first block further includes a second control logic configured to perform a clock gating operation on each of the plurality of IP blocks based on the power control signal.

8. The semiconductor system of claim 7, further comprising:
a second block including a second bus and a clock gating controller,
wherein the first processing block further includes a first bus configured to perform data communication with the second bus through the clock gating controller, and
the second control logic is configured to transmit a clock signal to the clock gating controller and perform a clock gating operation on the clock gating controller.

9. The semiconductor system of claim 8, wherein
the clock gating controller is configured to transmit a low power interface (LPI) accept to the second control logic in response to no data being present to be transmitted to the first bus through the data communication after receiving, from the second control logic, an LPI request generated based on the power control signal, and
the second control logic is configured to perform the clock gating operation based on the LPI accept.

10. The semiconductor system of claim 9, wherein
the second bus is configured to transmit a wakeup request to the first control logic in response to there being data to be transmitted to the first bus through the data communication,
the clock gating controller is configured to transmit an LPI deny to the second control logic in response to there being data to be transmitted to the first bus through the data communication after receiving the LPI request,
the second control logic is configured to supply a clock signal to the clock gating controller based on the LPI deny, and
the first control logic is configured to perform a wakeup operation on the first processing block based on the wakeup request.

11. The semiconductor system of claim 1, wherein the controller is configured to perform a power gating auxiliary operation on the first processing block through communication with the first control logic.

12. An operating method of a semiconductor system comprising a plurality of blocks, the operating method comprising:
determining an active state of each of a plurality of intellectual property (IP) blocks included in a first block among the plurality of blocks;
performing a power off operation on the first block in response to the active states of the plurality of IP blocks all being idle states; and
performing a wakeup operation on the first block based on a wakeup request received by a second block among the plurality of blocks.

13. The operating method of claim 12, wherein the performing of the power off operation includes performing the power off operation in response to the active states of the plurality of IP blocks all remaining in the idle states for more than a threshold time.

14. The operating method of claim 12, wherein
the performing of the power off operation includes,
operating, by the second block, in a stall mode in which data communication is stopped in response to there not being data to be transmitted from the second block to the first block through the data communication; and
performing the power off operation on the first block after the second block operates in the stall mode.

15. The operating method of claim 14, wherein
the performing of the power off operation includes,
transmitting, by the second block, the wakeup request in response to there being data to be transmitted from the second block to the first block to the first block through the data communication; and
stopping the power off operation on the first block based on the wakeup request.

16. The operating method of claim 14, wherein
the performing of the power off operation includes,
performing a clock gating operation on a clock gating controller included in the second block in response to there being no data to be transmitted from the second block to the first block through the data communication; and
performing a power gating operation on the first block after the clock gating operation.

17. The operating method of claim 16, wherein
the performing of the power off operation includes
transmitting, by the second block, the wakeup request to the first block in response to there being data to be transmitted from the second block to the first block through the data communication; and
stopping the power off operation on the first block based on the wakeup request.

18. An operating method of a semiconductor system comprising a plurality of blocks, the operating method comprising:
determining an active state of each of a plurality of intellectual property (IP) blocks included in a first block among the plurality of blocks;
determining data to be transmitted from a second block among the plurality of blocks to the first block through data communication in response to the active states of the plurality of IP blocks all being idle states;
stopping the data communication in response to there being no data to be transmitted through the data communication;
performing a power off operation on the first block after the data communication is stopped; and
performing a wakeup operation on the first block based on a wakeup request received by the second block.

19. The operating method of claim 18, wherein
the performing of the power off operation includes
transmitting, by the second block, the wakeup request in response to there being data to be transmitted through the data communication after the data communication is stopped; and
stopping the power gating operation based on the wakeup request.

20. The operating method of claim 18, wherein the determining of the data to be transmitted through the data communication includes determining the data to be transmitted through the data communication in response to the active states of the plurality of IP blocks all remaining in the idle states for more than a threshold time.
